(19) United States
(12) Patent Application Publication
(10) Pub. No.: US 2009/0065096 A1
(43) Pub. Date: Mar. 12, 2009

(54) Moulder

(75) Inventor: Heinrich Englert, Lauda-Konigshofen (DE)

Correspondence Address: GUDRUN E. HUCKETT DRAUDT, SCHUBERTSTR. 15A, WUPPERTAL, 42289, DE

(73) Assignee: MICHAEL WEINIG AKTIENGESELLSCHAFT, Tauberbischofsheim (DE)

(21) Appl. No.: 12/280,552

(22) PCT Filed: Feb. 22, 2007
(86) PCT No.: PCT/EP07/01537

§ 371 Date: Sep. 13, 2008

(30) Foreign Application Priority Data
Feb. 23, 2006 (DE) 10 2006 009 421.2

(51) Int. Cl. B27M 3/00

(52) U.S. Cl. 144/345

(57) ABSTRACT

A moulder has a first feeding unit and a transport path on which a workpiece is transported by the first feeding unit in an advancing direction At least one stop is arranged at the transport path. Horizontal spindles and vertical spindles each provided with a tool are provided for machining the workpiece. A second feeding unit is provided for moving the workpiece in the advancing direction. For machining the workpiece when the workpiece is moved by the second feeding unit, a first one of the vertical spindles is utilized.

The invention concerns a moulder according to the preamble of claim 1.

In moulders, the workpieces are sequentially fed to various tools with which the longitudinal sides of the workpieces extending in the transport direction are planed and/or longitudinally profiled. The workpieces machined in this way are utilized in furniture building or for window frames or door frames, for example.

In a known molder (DE 197 51 033 A1), on a transverse carriage a vertical spindle is provided with which the end face of the workpieces can be machined also. For this purpose, the transverse carriage together with the spindle is moved transversely to the advancing direction of a feeding unit past the stationary workpiece.

The invention has the object to design a moulder of the aforementioned kind in such a way that in a constructively simple way a universal machining of the workpieces is enabled by it.

This object is solved for a moulder of the aforementioned kind in accordance with the present invention by the characterizing features of claim 1.

In the moulder according to the invention, the workpieces are transported through the moulder for their longitudinal profiling by means of the first feeding unit that is preferably configured in the form of transport rolls resting on the workpiece. The vertical spindles are positioned to the right and to the left of the workpiece so that the workpiece during passage through the machine is profiled on both longitudinal sides by the tools seated on the spindles. By means of the second feeding unit, the workpiece can be transported through the moulder in the same advancing direction as with the first feeding unit. For example, the workpiece can be machined by means of the second feeding unit at the end faces for which purpose one of the vertical spindles is employed, or rather the tool seated on it. The workpiece is passed across an appropriate side of this vertical spindle and the tool seated thereon machines the workpiece. The second feeding unit can be used, for example, also for longitudinal machining of short workpieces that are so short that they cannot be transported, or transported only unreliably, through the moulder by means of the first feeding unit.

Advantageously, the vertical spindle remains in its position when machining the workpiece with the second feeding unit.

The second feeding unit is advantageously moved into the working position when machining of the workpiece is to be carried out with this feeding unit.

The second feeding unit has advantageously a support table that is movable in a direction in which the workpiece is to be moved for longitudinal machining by the moulder. Accordingly, for the longitudinal and transverse machining on the moulder only one feeding device is required, for example. The moulder has thus a very simple configuration.

In order for the workpiece to be machined properly, it is clamped on the support table of the second feeding unit.

In order to ensure a precise position of the workpiece during machining on the support table of the second feeding unit, its support table is provided with a workpiece stop.

In order to enable machining of the workpiece at different angles relative to the advancing direction, the workpiece stop of the second feeding unit is advantageously adjustable at various angles relative to the advancing direction.

The second feeding unit is advantageously moveable from a rest position into the working position.

It is particularly advantageous in this connection to move the second feeding unit from the rest position into the working position and vice versa by a pivot movement.

In the rest position, the second feeding unit is advantageously behind a cover of the machine so that, as long as the second feeding unit is not in use, it is not recognizable from the exterior. Moreover, the second feeding unit is protected behind the cover with regard to soiling and/or from damage.

In order for the second feeding unit to be movable from this position behind the cover into the working position, at least one part of the machine cover is removable, advantageously pivotable. It is then possible without problems to pivot the second feeding unit from the rest position into the working position, for example. The pivot axis is positioned advantageously horizontally so that the feeding unit in the working position is higher than in the retracted rest position.

The support table is advantageously slidable on at least one guide of the second feeding unit.

So that the guide is prevented from impacting machine parts upon pivot movement of the feeding unit from the rest position into the working position, the second feeding unit is advantageously positioned on at least one carrying device whose length is changeable. In this way, it is possible to arrange the feeding device during the pivoting action in such a way that a collision with machine parts is impossible.

When the support side of the support table of the second feeding unit is positioned higher than the support side of the transport path, it is e.g. not necessary to remove the pressing elements and linear stops for longitudinal machining that are provided on the vertical spindle now utilized for transverse machining; they can remain on the moulder.

The drive for the second feeding unit can be a motor drive.

In an embodiment according to claim 16 the feeding action of the second feeding unit is derived from the first feeding unit. In this way, only one drive is required in order to transport the workpieces for longitudinal and e.g. transverse machining through the moulder.

As a drive for the second feeding unit, advantageously an auxiliary device is provided. It rests advantageously on the transport path.

The auxiliary device is advantageously driven by the first feeding unit.

In order to transmit the advancing force, exerted by the first feeding unit onto the auxiliary device, to the second feeding unit, the auxiliary device is connected in the advancing direction to the second feeding unit.

In an advantageous embodiment, the auxiliary device is provided with two strips that extend parallel to one another and that are connected to one another by a transverse strip. The two strips extend advantageously in the advancing direction.

One of the strips is attached to the support table of the second feeding unit.

The other strip of the auxiliary device is advantageously guided on the transport path. In this connection, this other strip can be guided on the linear stop of this transport path in the advancing direction.

In order to be able to machine workpieces of different width and length and to derive in this connection the drive action from the first feeding unit, the transverse strip connecting the two strips is adjustable across the length of at least one of the strips.

In an embodiment according to claim 25, the second feeding unit of the moulder is utilized for longitudinal machining of short workpieces. These workpieces are so short that by means of the first feeding unit they cannot be properly guided, in particular they are not engaged by the advancing rolls. These short workpieces can be clamped on the support table of the second feeding unit in such a way that they can be moved by the feeding unit past the vertical spindle so that they can be machined on one of their longitudinal sides.

In order to enable this, the workpiece stop is advantageously adjustable forwardly in the advancing direction on the support table to such an extent that it extends in the advancing direction of the support table of the second feeding unit.

According to the embodiment of claim 27, the second feeding unit of the moulder is utilized for transverse machining of the workpieces.

The workpieces are comprised advantageously of wood but can also be made of plastic material or other appropriate materials.

Further features of the invention result from the additional claims, the description, and the drawings.

The invention will be explained in more detail with the aid of the embodiment illustrated in the drawings. It is shown in:

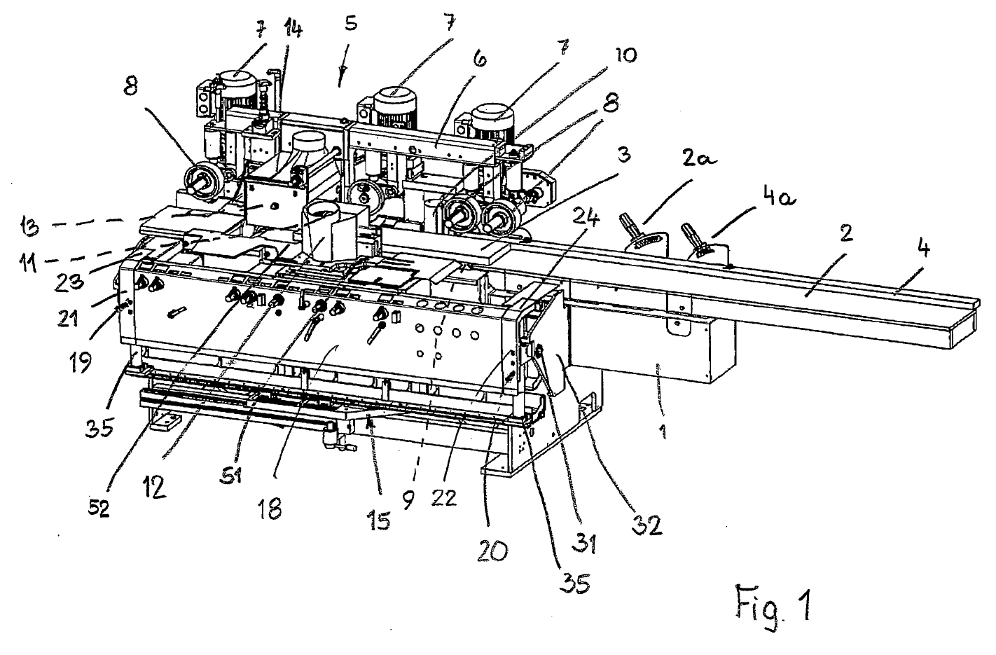

FIG. 1 a perspective illustration of a moulder according to the invention;

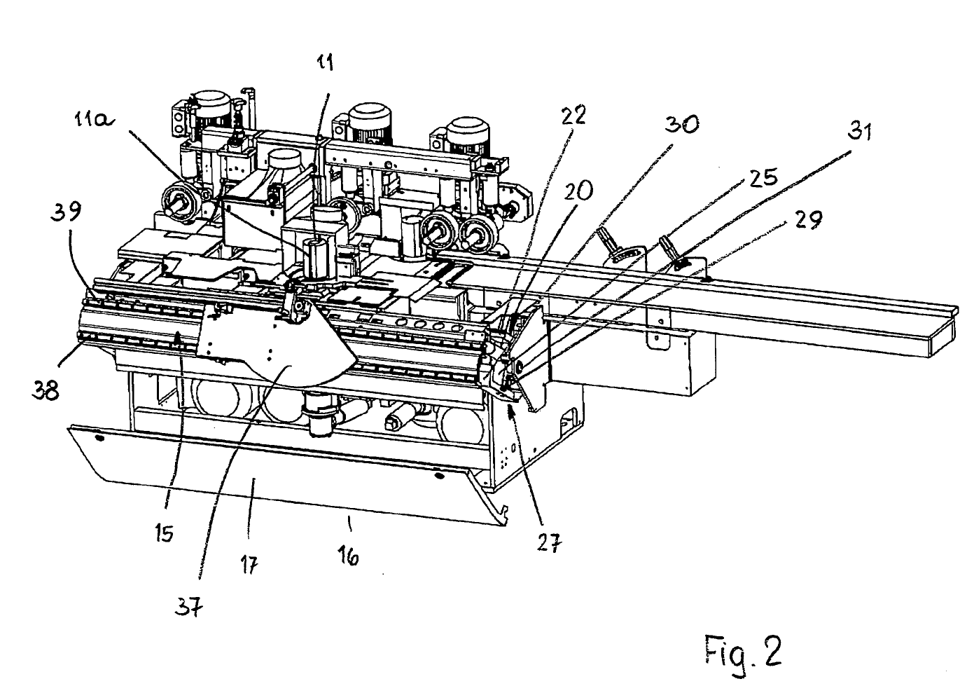

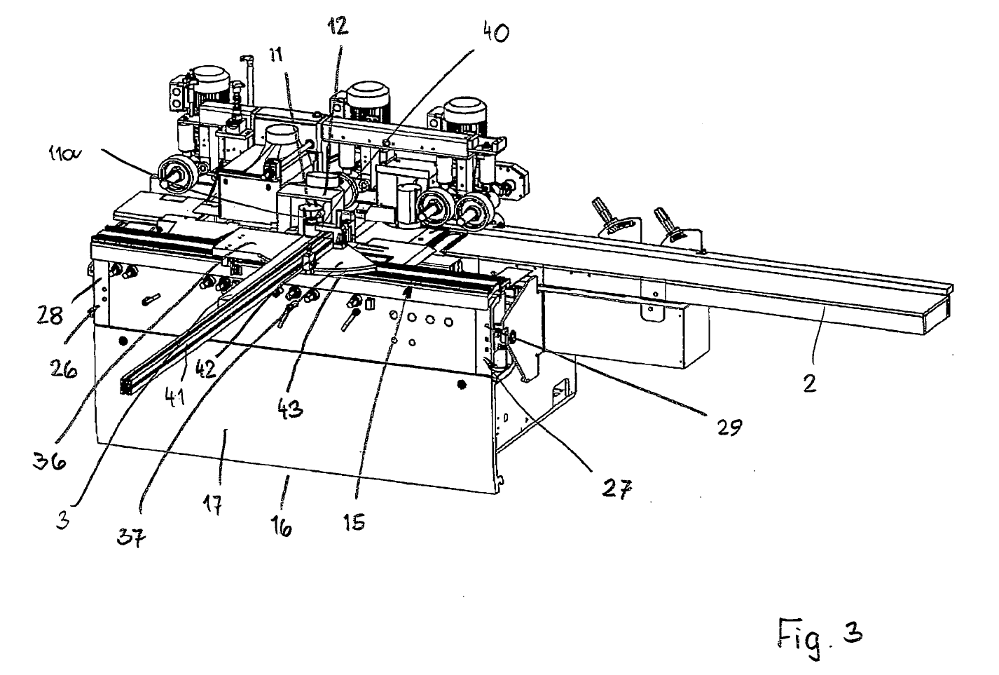

FIG. 2 the moulder according to FIG. 1 with a feeding unit that has been pivoted outwardly for transverse profiling;

FIG. 3 the moulder with the feeding unit pivoted completely;

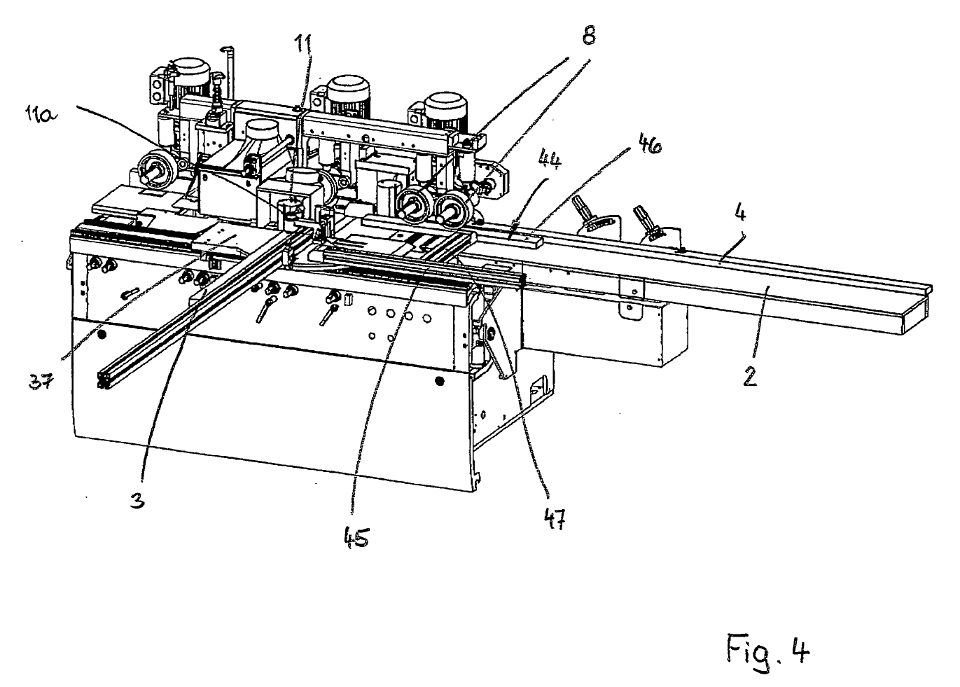

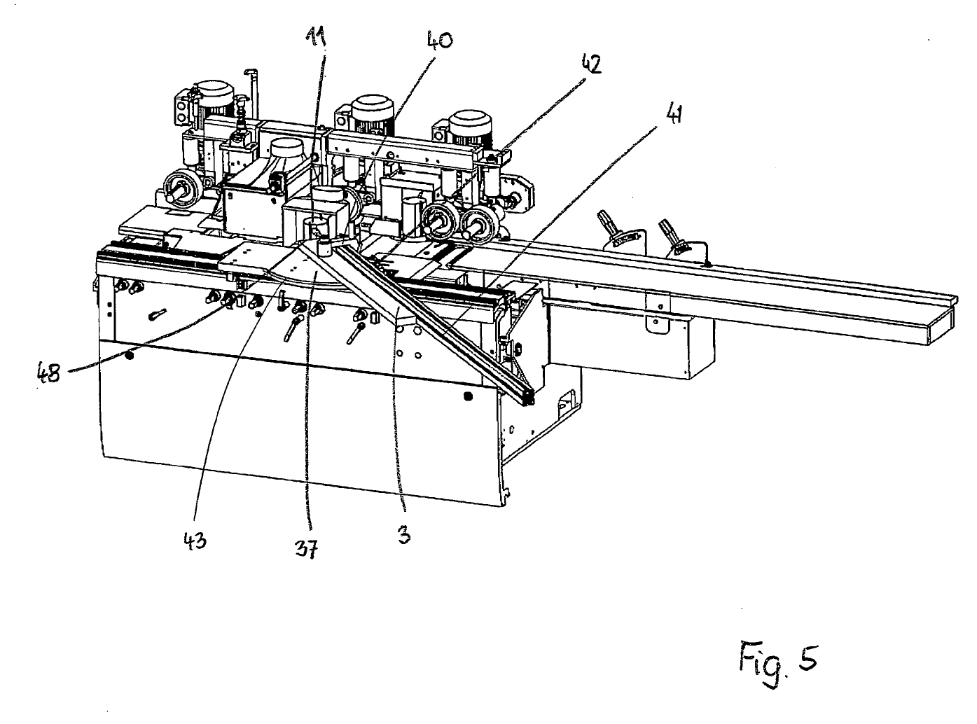

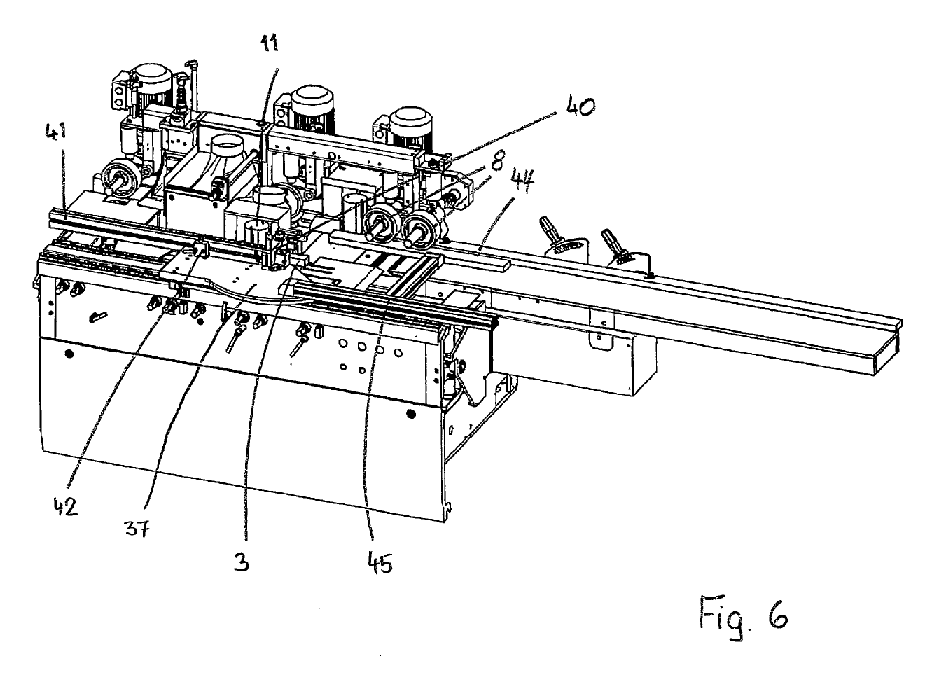

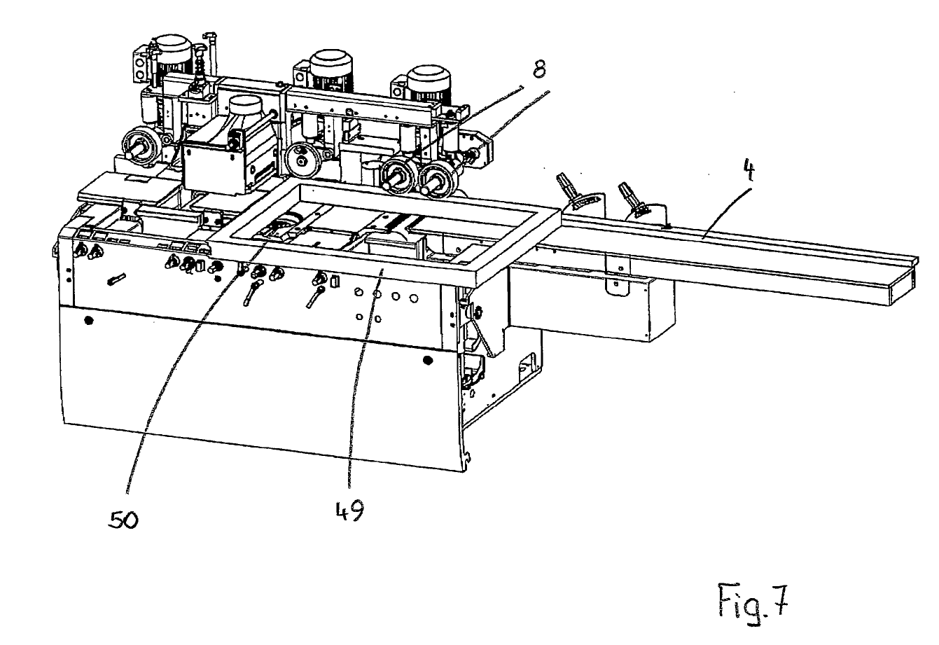

FIG. 4 an illustration in accordance with FIG. 3 of the moulder with an auxiliary feeding device;

FIG. 5 the moulder according to FIG. 3 with pivoted workpiece stop;

FIG. 6 the moulder according to the invention on which a short workpiece is machined in the longitudinal direction;

FIG. 7 the moulder on which a window frame is circumferentially milled;

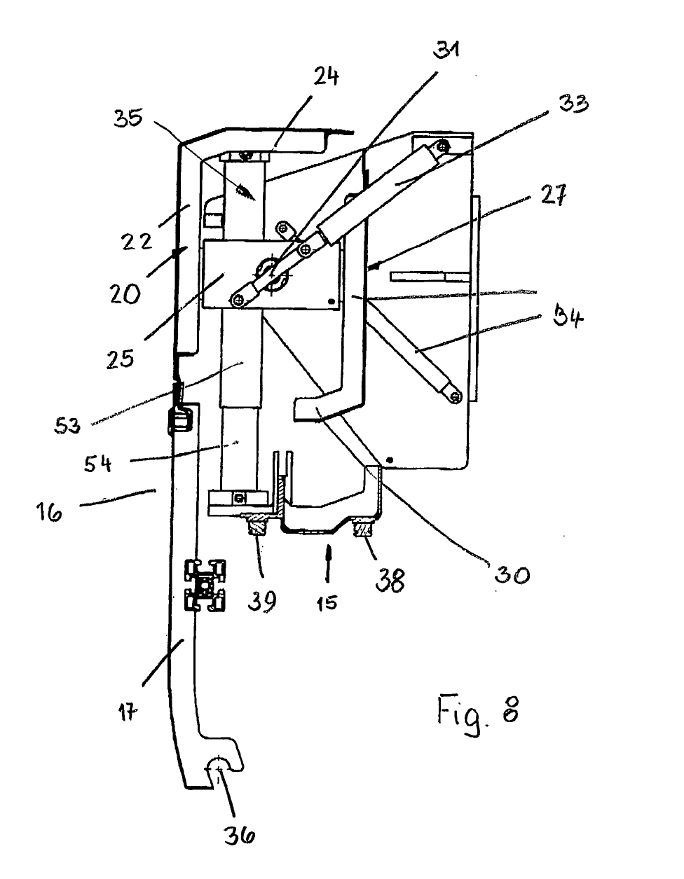

FIG. 8 the feeding unit of the moulder according to the invention that has been pivoted into a rest position, shown in a schematic illustration and in a sectioned side view;

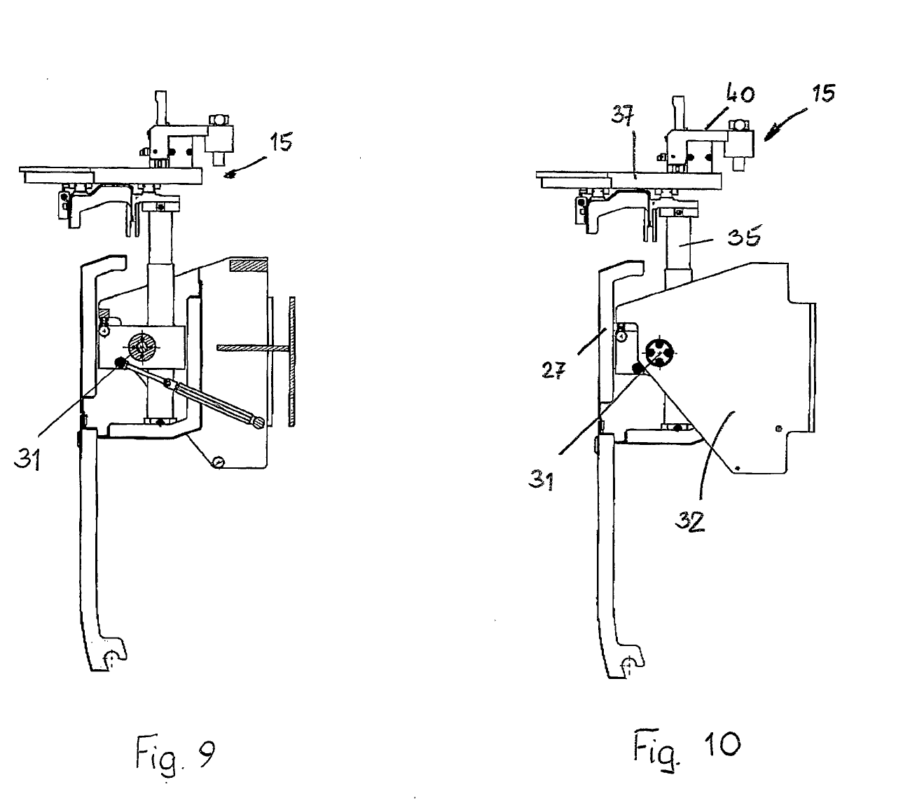

FIG. 9 the feeding unit pivoted into the working position in a section view;

FIG. 10 an illustration in accordance with FIG. 9 in a side view;

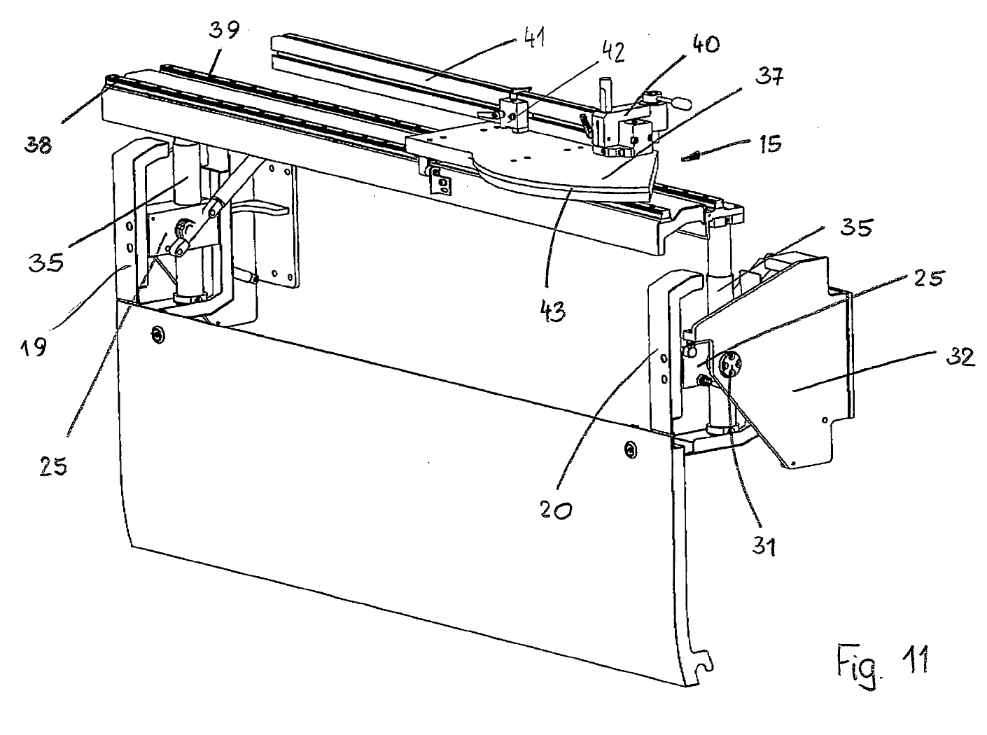

FIG. 11 a perspective and schematic illustration of the feeding unit in the working position before being pivoted into the rest position;

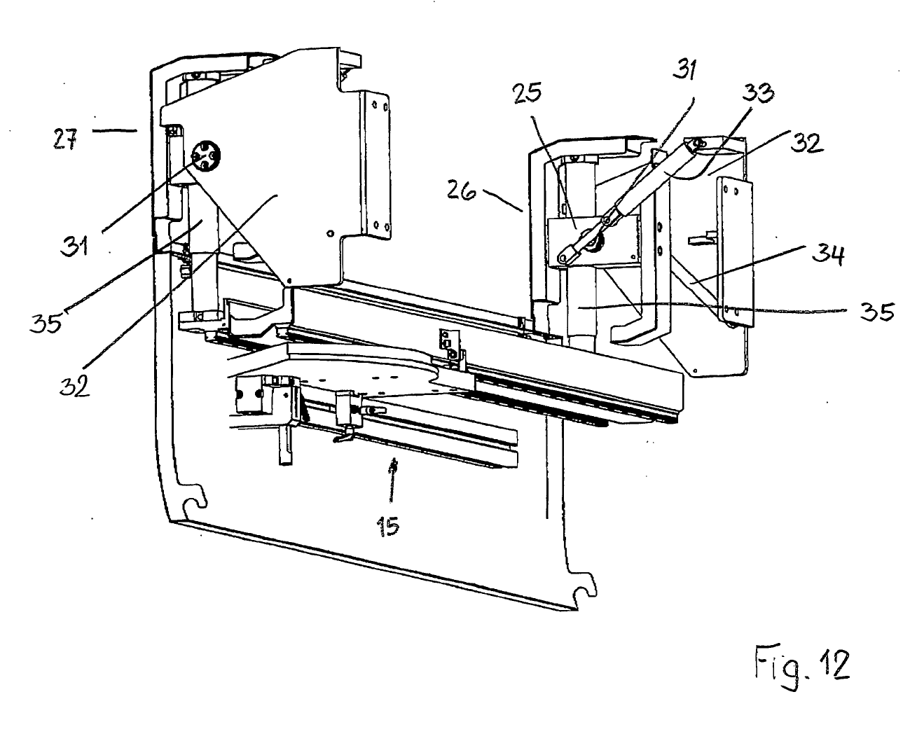

FIG. 12 a perspective illustration in a view from the rear of the feeding unit pivoted into the moulder.

The moulder has a frame 1 on which a support table 2 for the workpieces 3 to be machined is arranged. The support table 2 is provided on the right side in the transport direction of the workpieces 3 through the moulder with a linear stop 4 against which the workpieces 3 rest during transport through the moulder. For transporting the workpieces 3 a feeding unit 5 is provided that has a support 6 arranged in the area above the support table 2 and supporting advancing motors 7 for the advancing rolls 8. They are resting against the workpiece 3 and transport it through the moulder.

The workpiece 3 is machined as it passes through the moulder on all four sides by appropriate tools. First, the workpiece 3 is machined by means of a tool seated on a lower horizontal spindle 9 upon passing through the moulder. The tool seated on this spindle 9 is generally a planing tool. At a spacing behind the lower spindle 9 there is a vertical right spindle 10 on which a tool is positioned with which the right longitudinal side of the workpiece 3 in the advancing direction is machined. In the advancing direction at a minimal spacing behind the right spindle 9 the moulder is provided with a vertical left spindle 11 on which a tool is seated with which during passage the left longitudinal side of the workpiece 3 in the advancing direction is machined. The left spindle 11 is positioned within a suction hood 12 with which the cuttings that are produced during machining are removed by suction as is known in the art. Finally, in the advancing direction behind the longitudinal profiling spindles 10, 11, there is an upper horizontal spindle 13 that is also located under a further suction hood 14 and on which an appropriate tool, for example, a planer, is seated. Advantageously, in the advancing direction behind the upper horizontal spindle 13 a further horizontal lower spindle is located. The workpiece 3 is therefore machined during its passage through the machine by tools seated on the spindles 9 to 11 and 13 at the top and bottom sides as well as on the right and left longitudinal sides.

The support table 2 is comprised essentially of two parts of which the first part in front of the lower spindle 9 is height-adjustable for adjusting the chip removal. The linear stop 4 is also comprised substantially of two parts of which the part in front of the right vertical spindle 10 is adjustable in a horizontal plane for adjusting the chip removal. Adjusting elements 2a, 4a are provided for adjusting this chip removal.

By means of the moulder it is possible in a simple way not only to carry out the afore described longitudinal machining but also a transverse machining on the workpiece 3 at the end face. For this purpose, the moulder is provided with a further feeding unit 15 that, in case of longitudinal machining of the workpiece 3, is in a rest position. Advantageously, the feeding unit 15 is located behind a front cover 16 (FIG. 2) that is not illustrated in FIG. 1. From the rest position the feeding unit 15 can be pivoted into the working position illustrated in FIG. 3 in which position the end faces of the workpiece 3 can be machined in a way to be described in the following. The front cover 16 has a lower cover part 17 that extends across the length of the moulder and is substantially panel-shaped. In the upper direction an operating panel 18 adjoins the cover part 17 on which the required actuating elements, switches, levers, and the like required for operating the moulder are located. On either side of this operating panel 18 there are two L-shaped strips 19, 20 that adjoin the operating panel 18 and extend to the upper edge of the cover part 17. In the position illustrated in FIG. 1, the longer legs 21,22 of the strips 19, 20 are positioned vertically while the shorter legs 23, 24 are positioned horizontally and extend in a direction toward the support table 2. The strips 19, 20 are attached with inner sides of their long legs 21, 22 to a tab 25, respectively, that fixedly connect the strips 19, 20 with further L-shaped strips 26, 27 (FIGS. 2, 3, and 8). When the feeding unit 15 is in its rest position, these strips 26, 27 are positioned within the machine frame 1. The tabs 25, as shown in FIG. 8 for the strip 27, are attached to the inner side of the long leg 28, 29 of this strip. The shorter leg 30 of the strips 26, 27 is shorter than the short leg 23, 24 of the strips 19, 20. As can be seen in FIG. 8, the strips 19, 20 and 26, 27 are arranged relative to one another in a position rotated by 180 degrees. The tabs 25 are seated on a horizontal axis 31, respectively, that forms a pivot axis for the feeding unit 15 in order to be able to pivot it from the rest position into the working position and vice versa. The axes 31 are provided on lateral panels 32 that are attached to the machine frame 1 and are located behind a lateral cover of the machine that is not illustrated in FIG. 1. The tabs 25 are engaged by adjusting cylinders 33, 34 that are connected with one end pivotably to the lateral panels 32 and with the other end at the piston rod are pivotably connected to the tabs 25. By extension and retraction of the piston rods of the adjusting cylinders 33, 34 the tabs 25 can be rotated about axes 31.

At a right angle to the bottom side of the shorter legs 23, 24 of the strips 19, 20 a carrying device 35 is provided that extends parallel to the long legs 21, 22 of the strips 19, 20. The carrying device 35 has an exterior tube 53 that is secured to the tab 25 and in which an inner tube 254 is slidably arranged. In the exterior tube 53 a pneumatic spring is arranged (not illustrated) that moves the inner tube 54 outwardly into the end position illustrated in FIG. 8. The pneumatic spring is designed such that in the working position the feeding unit 15 cannot return the inner tube 54 against the force of the pneumatic spring.

FIG. 8 shows the feeding unit 15 in its rest position. The carrying device 35 projects perpendicularly downwardly and supports at its free end the feeding unit 15. Relative to the exterior, the feeding unit 15 is arranged together with the described adjusting device behind the front cover 16 as well as the operating panel 18 of the machine and is therefore not visible from the exterior. When a transverse machining off the workpiece is to be carried out, the feeding unit 15 is pivoted about the axes 31 upwardly from the rest position illustrated in FIG. 8 into the working position which is illustrated in FIGS. 3 and 9 through 11. The adjusting cylinders 33, 34 are actuated appropriately so that the tabs 25 are rotated about axes 31 in the desired direction. Since the strips 19, 20 and 26, 27 are fixedly connected to the tabs 25, they are entrained when this pivot movement occurs. Also, the devices 35 supporting the two ends of the feeding unit 15 are entrained. In order for the feeding unit 15 to be pivoted into the working position, first the cover part 17 of the front cover 16 is pivoted away about a horizontal axis 36 at the lower edge (FIG. 8) so that the feeding unit 15 is pivoted past the cover part 17 in the upward direction.

Instead of the adjusting cylinders 33, 34, it is also possible to employ weight compensation elements, preferably gas springs. In this case, the feeding unit 15 is pivoted manually from the rest position into the working position and vice versa. The weight compensation elements facilitate the adjusting process.

FIG. 2 shows a central position of the feeding unit 15 when moving it from the rest position into the working position. In FIG. 3, the feeding unit 15 is in its working position. The cover part 17 of the front cover 16 has again been pivoted back so that the front side of the moulder is closed. Since the inner tubes 54 of the carrying device 35 have been completely extended by means of the pneumatic spring, the feeding unit 15 can be reliably pivoted without collision into the working position in which it is located in the area above the support table 2. Now, the inner tubes 54 of the carrying devices 35 can be moved by hand against the force of the pneumatic springs into the exterior tubes 53 until the feeding unit rests on the machine frame and can be locked thereon. FIG. 3 shows the working position of the feeding unit 15. The working plane 36 of the feeding unit 15 is positioned advantageously higher than the support plane of the support table 2. In this way, the pressing elements 51 and the linear stops 52 used for longitudinal profiling of the workpiece 3 can remain at the left spindle 11 and must not be removed. The workpiece and the support in this case can be moved across the pressing elements 51 and the linear stops 52 of the left spindle 11 in case of transverse profiling. The strips 26, 27 assume in the working position of the feeding unit 15 the position of the strips 19, 20 and thus adjoin, like the latter do, the operating panel 18.

Of course, it is also possible to provide the working plane 36 of the feeding unit 15 at the same level as the plane of the table. In this case, it is however required to remove the pressing elements 51 and the linear stops 52 for longitudinal profiling provided at the left spindle 11 before adjusting the feeding unit 15 into the working position.

Instead of the carrying devices 35 it is also possible to employ adjusting cylinders with which the feeding unit 15 is height-adjustable. In this case, it is connected to the piston rods of the adjusting cylinder. The adjusting action of the feeding unit 15 from the rest position into the working position and vice versa can then be realized fully automatically.

The feeding unit 15 has a support table 37 whose topside forms the working plane 36. The support table 37 is moved on the feeding unit 15 along two guides 38, 39 for transverse machining of the workpiece 3. The guides 38, 39 extend parallel to the feeding unit of the workpieces during longitudinal profiling. The guides 38, 39 are advantageously ball tracks with which the support table 37 can be moved easily. The workpiece 3 is clamped onto the support table 37. For this purpose, on the support table 37 a corresponding clamping device 40 (FIG. 3) is provided.

The support table 37 can be moved by hand, by a motor, or by an auxiliary device along guides 38, 39 when transversely machining the workpieces 3. In case of a motor drive, the moulder is provided with an appropriately controllable axis. On the support table 37 a workpiece stop 41 is provided against which the workpiece 3 rests during transverse machining. The workpiece stop 41, as can be seen when comparing FIGS. 3 and 5, can be pivoted relative to the advancing direction of the support table 37. In the position according to FIG. 3 the workpiece stop 41 extends perpendicularly to the transport direction of the support table 37. It is provided with a lock 42 that is adjustable in a recess 43 provided on the topside of the support table 37 which recess is of a part-circular shape. In the adjusted position, respectively, the stop 42 can be clamped in a known way. The workpiece stop 41 is fixedly connected to this lock 42. Instead of this infinitely variable angular adjustment, it is also possible to adjust the workpiece stop 41 in predetermined angular positions. For this purpose, on the support table 37 tooth segments with defined tooth spacing or defined tooth width can be provided that are engaged by a bolt that is supported on the workpiece support 41. Likewise, insertion openings can be provided on the support table 37 into which a bolt can be inserted that, for example, is inserted through a through opening in the workpiece support 41 or through a tab that projects from it.

For transverse machining, the left vertical spindle 11 is moved into a fixed position relative to the linear stop 4, taking into consideration the cutting circle of the tool seated on it. The linear stop 4 forms a horizontal reference point for the moulder. The workpieces 3 are adjusted by a stop (not illustrated) that is preferably adjustable relative to this reference point and thus relative to the spindle 11 provided with the transverse machining tool.

Before upwardly pivoting the feeding unit 15 into the working position, the suction hood 12 associated with the spindle 11 is repositioned so that the tool seated on the spindle 11 can machine the narrow side of the workpiece 3. The support table 37 with the clamped workpiece 3 is moved along guides 38, 39 past the tool seated on the spindle 11 which tool machines the corresponding end face or narrow side of the workpiece 3. By means of the workpiece stop 41 and the stop (not illustrated), the workpiece 3 can be precisely aligned for transverse machining and securely clamped by means of the clamping device 40.

FIG. 4 shows a possibility how the support table 37 with the clamped workpiece 3 can be moved past the spindle 11. For this purpose, an auxiliary feeding device 44 is provided that has approximately the shape of an H. This auxiliary device has a strip 45 that extends in the transport direction of the support table 37 and is attached with one end to the support table 37. On the opposite side, the auxiliary device is provided with a further strip 46 that is moved while resting against the linear stop 4 of the support table 2. The two strips 45, 46 are connected to one another by a strip 47 that is perpendicular thereto. The strip 46 is moved along the linear stop 4 until it is engaged by the advancing rolls 8. By means of the rolls the entire auxiliary device 44 is transported in the advancing direction. In this way, the same drive that is used for the workpiece 3 for longitudinal machining can also be used as a driving action for transverse machining of the workpiece 3. The transverse strip 47 is fixedly connected to the strip 46 but is detachably connected to the strip 45. In this way, it is possible to adjust the transverse strip 47 as well as the strip 46 in the advancing direction relative to the strip 45 in such a way that the transport rolls 8 for different widths of the pieces of wood 3 will engage the strip 46 and, in this way, can move by means of the auxiliary device 44 the support table 37 with the clamped workpiece 3 in the advancing direction. The transverse strip 47 can be clamped in any position on the strip 45. Since the transverse strip 47 can be moved in an infinitely variable way along the strip 45, a precise adjustment of the machine relative to the workpieces 3 to be machined in the transverse direction is ensured. Advantageously, the strip 46 is made of plastic material so that the advancing rolls 8 and the support table 2 cannot be damaged or worn prematurely.

The auxiliary device 44 can be attached by means of the strip 45 without problems to the support table 37 and can also be removed again.

FIG. 5 shows the workpiece stop 41 in a pivoted position. The lock 42 has been moved along the recess 43 of the support table 37 into the desired position and clamped thereon. The workpiece 3 is positioned on the workpiece stop 41 and is clamped by means of the clamping device 40 on the support table 37. The support table 37 is moved past the vertical spindle 11 so that the corresponding narrow side 48 of the workpiece 3 is processed accordingly at a slant.

In FIG. 6 the workpiece stop 41 has been pivoted in the advancing direction so far forwardly that it extends in the advancing direction of the support table 37 and thus parallel to the linear stop 4. By means of the lock 42 the workpiece stop 41 is positionally secured on the support table 37. The workpiece 3 is clamped by means of clamping device 40 on the support table 37 and has only minimal length. The workpiece 3 can be shorter than the spacing of the transport rolls 8. Since the workpiece stop 41 extends in the advancing direction of the support table 37, the longitudinal side of the workpiece 3 is machined by the tool seated on the left spindle 11 when advancing the workpiece. The spindle 11 in this case is positioned on the right side of the workpiece 3 in the advancing direction and machines accordingly the right workpiece side. As has been explained in connection with FIG. 3, the support table 37 can be moved manually, by a motor drive or by means of the auxiliary feeding device 44. In the illustrated embodiment, for advancing the support table 37 the auxiliary device 44 is used that is actuated by means of the transport rolls 8 in the described way. Since the strip 45 is connected to the support table 37, in this way the support table 37 is moved with the clamped workpiece 3 past the spindle 11.

The position of the workpiece stop 41 in accordance with FIG. 6 is provided for short workpieces, as illustrated, but also for workpieces that are difficult to transport.

FIG. 7 shows the possibility of circumferentially milling by means of the moulder a frame 49, for example, a window frame. Even large panels can be machined at their edges in the way to be described in the following. In order to be able to transport the frame 49 through the moulder, the tool 11a of the spindle 11, the associated pressing elements 51, linear stops 52, as well as suction hood 12 are removed. The tool 11a of the left spindle 11 is provided with a HSK interface so that it can be very easily clamped in and removed from a corresponding HSK receptacle 50 of the spindle 11 of the moulder. In this way, retooling of the moulder required for machining the frame 49 or panels can be done in a simple way and primarily quickly. The feeding unit 15 has been pivoted back from the working position into the rest position in the downward direction. For this purpose, first the feeding unit has been released and is then lifted by means of the inner tubes 54 that are extended by the pneumatic springs out of the exterior tubes 53 together with guides 38, 39. The cover part 17 is pivoted away about the axis 36. Subsequently, the tabs 25 are pivoted back by means of the adjusting cylinders 33, 34 about axes 31 into the position illustrated in FIG. 8 and subsequently the cover part 17 is returned into its initial position. Subsequently, removal of the tool 11a of the left spindle 11 and the associated parts including the suction hood 12 can be carried out. The transport rolls 8 are resting on one of the frame sides and transport the frame 49 through the moulder. In the advancing direction the frame 49 is guided by the linear stop 4.

The spindle 11 and/or the associated pressing elements 51, linear stops 52, and suction hood 12 can also be provided so as to be pivotable on the moulder. In this case, the moulder can be simply and quickly retooled for processing the frame 49 or a panel.

When the frame 49 or the panel are sufficiently small, it can be moved by means of the feeding unit 15 past the vertical spindle 11 for circumferential milling. In this case, the described retooling is not required.

By means of the moulder it is also possible to simultaneously carry out longitudinal and transverse machining on workpieces. For this purpose, only three sides of the workpiece, without the left side, for longitudinal machining and the end face of another workpiece would be machined simultaneously.

It is furthermore possible to move the spindle 11 behind the linear stop 4 in alignment to the right vertical spindle 10 or vice versa to move the right vertical spindle 10 in alignment to the left spindle 11. In this case, it is possible to perform same direction / counter direction machining of the workpiece for preventing splitting as the machining tool exits from the workpiece.

What is claimed is:

1.-27. (canceled)

28. A moulder comprising:
a first feeding unit;
a transport path on which a workpiece is transported by the first feeding unit in an advancing direction;
at least one stop arranged at the transport path;
horizontal spindles and vertical spindles each provided with a tool for machining the workpiece;
a second feeding unit for moving the workpiece in said advancing direction;
wherein for machining the workpiece when the workpiece is moved by the second feeding unit, a first one of said vertical spindles is utilized.

29. The moulder according to claim 28, wherein said first vertical spindle maintains a position when machining the workpiece when moved by the second feeding unit.

30. The moulder according to claim 28, wherein the second feeding unit is moveable into a working position by the first feeding unit.

31. The moulder according to claim 28, wherein the second feeding unit comprises a support table that is moveable in the advancing direction of the workpiece during longitudinal machining.

32. The moulder according to claim 31, wherein the support table has means for clamping the workpiece on the support table.

33. The moulder according to claim 31, wherein the support table is provided with a workpiece stop.

34. The moulder according to claim 33, wherein the workpiece stop is adjustable at different angles relative to the advancing direction.

35. The moulder according to claim 28, wherein the second feeding unit is moveable from a rest position into a working position.

36. The moulder according to claim 35, wherein the second feeding unit is pivotable from the rest position into the working position.

37. The moulder according to claim 35, wherein the moulder has cover and the second feeding unit is positioned behind the cover in the rest position.

38. The moulder according to claim 37, wherein the cover has at least one part that is removable so that the second feeding unit is pivotable in and out of the rest position.

39. The moulder according to claim 28, wherein the second feeding unit comprises a support table and at least one guide on which the support table is moveable.

40. The moulder according to claim 39, further comprising at least one carrying device on which the second feeding unit is supported, wherein the at least one carrying device is pivotable together with the second feeding unit.

41. The moulder according to claim 39, wherein a support side of the support table of the second feeding unit is positioned higher than a support side of the transport path.

42. The moulder according to claim 28, wherein the second feeding unit comprises a motor drive.

43. The moulder according to claim 28, wherein an advancing action of the second feeding unit is derived from the first feeding unit.

44. The moulder according to claim 28, further comprising an auxiliary device for advancing the second feeding unit.

45. The moulder according to claim 44, wherein the auxiliary device is resting on the transport path.

46. The moulder according to claim 44, wherein the auxiliary device is driven by the first feeding unit.

47. The moulder according to claim 44, wherein the auxiliary device is connected to the second feeding unit.

48. The moulder according to claim 44, wherein the auxiliary device has a first strip and a second strip extending parallel to one another, wherein the first and second strips are connected to one another by a transverse strip.

49. The moulder according to claim 48, wherein the first strip is attachable to a support table of the second feeding unit.

50. The moulder according to claim 48, wherein the second strip is guided on the transport path in the advancing direction.

51. The moulder according to claim 48, wherein the transverse strip is adjustable along at least one of the first and second strips.

52. The moulder according to claim 28, wherein the second feeding unit is utilized for longitudinal machining of a short workpiece.

53. The moulder according to claim 52, wherein the second feeding device has a support table with a workpiece stop, wherein the workpiece stop is adjustable on the support table in the advancing direction forwardly to such an extent that the workpiece stop extends in the advancing direction of the support table.

54. The moulder according to claim 28, wherein the second feeding unit is used for transverse machining of the workpiece.
